(19) United States
(12) Patent Application Publication
(10) Pub. No.: US 2020/0136160 A1
(43) Pub. Date: Apr. 30, 2020

(54) SIMPLIFIED FUEL CELL SYSTEM, APPARATUS, AND PROCESS

(71) Applicant: Gunes M. Ecer, Oceanside, CA (US)

(72) Inventor: Gunes M. Ecer, Oceanside, CA (US)

(21) Appl. No.: 16/655,384

(22) Filed: Oct. 17, 2019

Related U.S. Application Data
(60) Provisional application No. 62/766,532, filed on Oct. 24, 2018.

(51) Int. Cl. H01M 8/04746; H01M 8/04537; H01M 8/04858

(52) U.S. Cl. CPC H01M 8/04753; H01M 2008/1095; H01M 8/04932; H01M 8/04604

(57) ABSTRACT

A simplified fuel cell is disclosed for producing electricity which can include a sealed chamber having a first and second electrode separated from each other, wherein the first electrode includes an anode and the second electrode includes a cathode. The fuel cell also includes a load circuit disposed outside of the chamber and in electrical communication with the anode, and flowable ionizable matter disposed within the chamber, wherein the anode causes the flowable ionizable matter to ionize and produce electrons to move to the load circuit and return to the cathode. In addition, the fuel cell also includes a second proton circuit, wherein the ionization at the anode also produces positively charged ions moving to the cathode from the second proton circuit. A carrier fluid carries the positively charged ions traveling therein, wherein returning electrons and positively charged ions combine at the cathode, thereby reforming the flowable ionizable matter.

### CROSS REFERENCE TO RELATED APPLICATIONS

This application claims the benefit of U.S. Provisional Application No. 62/766,532 filed on Oct. 24, 2018, which is incorporated herein by reference in its entirety.

### FIELD

The present disclosure described herein relates to fuel cell processes that produce electricity, and electricity producing fuel cells. In one non-limiting exemplary embodiment, the disclosure described herein involves elimination of fuel consumption and exhaust matter during the production of electricity.

### BACKGROUND

This section is intended to introduce the reader to aspects of art that may be related to various aspects of the present disclosure described herein, which are described and/or claimed below. This discussion is believed to be helpful in providing the reader with background information to facilitate a better understanding of the various aspects of the present disclosure described herein. Accordingly, it should be understood that these statements are to be read in this light, and not as admissions of prior art.

As used herein, the term ‘fuel’ can be used to represent ionizable flowable matter. More specifically, fuel referred to can be hydrogen as it is the element used the most in conventional fuel cells. The application of the present disclosure described herein to fuel cell processes other than the hydrogen using fuel cell process will be apparent from this discussion.

Generally, a basic single fuel cell conventionally consists of a negative anode, a positive cathode, and an ion conducting (but not electron conducting) electrolyte in between. Hydrogen fuel is supplied to the anode, where a catalyst breaks down the hydrogen into electrons and protons. Electrons travel from the anode to the cathode though a ‘load’ circuit, performing work, such as lighting a light bulb, creating heat at a space heater, or running a computer, etc. The remaining positively charged hydrogen ions (protons) travel to the cathode within in electrolyte via diffusion from the higher concentration of ions to a lower concentration at the cathode. There, ions combine with oxygen supplied to the cathode, and electrons returning from the load circuit. Thus, water is produced as exhaust matter and expelled from the fuel cell. As byproduct, heat is also produced. This heat may be captured to increase the energy efficiency of the fuel cell system. Conventionally, both the anode and the cathode reactions are aided by catalysts, which speed up the reactions. Catalysts are usually fine platinum particles, or a coating of platinum, at the anode, and nickel or a nanomaterial-based catalyst at the cathode. The catalyst at the cathode turn the protons into waste products like water (and carbon dioxide in some types of conventional fuel cells) by combining with oxygen and the electrons returning from the load circuit.

Several basic types of fuel cell chemistry and more variations of the basic designs of conventional fuel cells exist. These are generally based around a design consisting of two electrodes, a negative anode and a positive cathode, but differ in the type of electrolyte used, and the types of chemicals that act as carrier fluid for the positively charged hydrogen ions (protons). The net result of the two reactions occurring at the electrodes is that the fuel is consumed, water (and/or carbon dioxide in some types fuel cells) is created, and an electric current is created, which can be used to power electrical devices, normally referred to as the ‘load.’

The chemical reactions for a basic conventional hydrogen fuel cell are:

At the anode: 2H₂→4H⁺+4e⁻

At the cathode: 4H⁺+4e⁻+O₂→2H₂O

Overall reaction: 2H₂+O₂→2H₂O

Basically, conventional fuel cells produce exhaust matter, and they utilize the fuel (hydrogen) only once. This is because at the cathode hydrogen ions (protons) arriving from anode combine with oxygen supplied to the cathode and electrons returning from the load circuit to form water as a waste product. In conventional fuel cells, hydrogen and oxygen must be supplied to the fuel cell for the cell to operate continuously. Thus, conventional fuel cell technology wastes the fuel by using it only once before it is turned into a waste product.

Conventionally, electrodes are separated by an electrolyte that may be liquid or solid. Electrolyte is designed to conduct ions, but not electrons. If free electrons or other substances could travel through the electrolyte, they would disrupt the chemical reactions at the anode and the cathode reaction may be affected as well. Based on the electrolyte type, fuel cells operate at different temperatures ranging up to 600° C.

Fuel cells can be connected in series to yield higher voltage, and in parallel to allow a higher current, which can be called a (cell) stack. Since electrode reactions occur at the triple junctions of electrode-electrolyte-fuel interface, electrode surface area can be increased to produce more current from each cell. Within the stack, reactant gases must be distributed uniformly over each of the cells to maximize the power output. Supplying reactant gasses uniformly requires fine engineering work and is costly as well. This is not required in the present disclosure described herein. Further, Polymer Electrolyte Membrane Fuel Cells (PEMFC) operate at around 80° C. This temperature is too low for high speed splitting of hydrogen and oxygen into ions, so platinum particles or a thin layer of platinum on the electrode typically used as catalyst.

In addition, the two electrodes and the electrolyte between them define a unit, which is called a membrane electrode assembly (MEA), and it is sandwiched between two field flow plates to form a fuel cell. Flow plates contain grooves to channel the fuel (to anode) and oxygen (to cathode). Each fuel cell produces enough power to run a light bulb (about 0.7 volts). But, for many applications like cars, for example, 300 volts or more may be needed. To produce such high voltages, several individual cells are typically combined in series to form a fuel cell stack.

At present, many conventional PEMFC demonstration and commercial units are in operation. Yet, there are many barriers to their wider use. In the conventional fuel-cell field, the main issue is the high cost of the membrane materials, catalysts, and, hydrogen. They also need pure hydrogen to operate, as they are very susceptible to poisoning by carbon monoxide and other impurities mainly from the air supplied to the cathode. Additionally, for mobile fuel cell applications, there is also the hydrogen refueling problem due to lack of enough hydrogen fueling stations. In addition, the reaction efficiency is limited by the rate of diffusion of protons away from the anode reaction surface.

Further, while hydrogen gas is a clean burning gas, it occupies a large volume. So, there is a storage problem associated with its wide usage. Fossil fuels are still needed to produce hydrogen. To separate the atoms of the hydrogen and oxygen and to generate hydrogen fuel, fossil fuels are needed. This completely defeats the purpose of an alternative energy source. If the world runs out of fossil fuels, we would no longer be able to produce hydrogen energy.

Hydrogen is also costly to produce, and the fuel cell itself is very expensive. Hydrogen is also flammable. However, the less hydrogen one uses, and less you handle it the lower is the potential dangers arising from hydrogen, such as fires and explosions.

Hence, what is needed is a more cost-effective solution to the energy creation using hydrogen would be better than the existing conventional fuel cells, wherein a method of using hydrogen just as a carrier of energy without turning it to waste products would conserve the fossil supply for hydrogen, among others.

### BRIEF SUMMARY

In one aspect of the disclosure described herein, a fuel cell method, system, and apparatus is disclosed that involves elimination of fuel consumption and exhaust matter during the production of electricity. This is achieved by eliminating the cathode reactions that produce exhaust matter. Instead, a fuel reforming spontaneous chemical reaction takes place at the cathode between the electrons returning from the ‘load circuit’ and the protons arriving from the anode via another circuit named the ‘proton circuit.’ In addition, the disclosure described herein allows use of a force means, such as mechanical (e.g., pump), physical, and chemical effects, to increase the travel speed of proton carrying fluid within the fuel cell chamber. Since the proton travel speed determines the reaction efficiency, fuel cell efficiency, expressed as electricity produced per unit time is increased. Further, hydrogen is used as an energy carrier. Hydrogen carries the energy forming electrons, which create an electro-magnetic energy field in the opposite direction to the electron flow. Further, the social benefits of the present disclosure described herein include near elimination of the cost of electricity production, allowing transportability without the necessity of a refueling network, and the elimination of the release of greenhouse gasses into the atmosphere in the process of producing electricity. Here, several variations or multiple non-limiting exemplary embodiments of the basic process of this disclosure are described. Further, various non-limiting exemplary embodiments of electricity producing apparatuses designed to utilize said process are also described.

In another aspect of the disclosure described herein, a fuel cell system, method, and apparatus for producing electricity is disclosed that eliminates exhaust waste products and many of the hardware in conventional fuel cells by eliminating the use of oxygen and using fuel as an energy carrier. This can be achieved by creating two separate circuits: one carrying electrons, and the other carrying protons. Both circuits operate by ionizing the fuel, such as hydrogen, at the anode. Electrons and protons, traveling on said two separate circuits, are combined at the cathode, reforming the fuel. Anode protons are carried to the cathode within a carrier fluid and react with electrons returning from the load circuit. The reformed fuel is then returned to the chamber atmosphere, and the carrier fluid is returned to the anode for the same ionization process to begin once again or repeating the cycle. Further, fuel cell efficiency is controlled by the travel speed of protons on the proton circuit. Application of a force such as physical, chemical, and mechanical forces to the proton carrier fluid allows higher fuel cell efficiencies. Thus, unlike the conventional fuel cell technology, the rate of electricity creation at the anode can be increased several folds; and, said rate unlike any conventional fuel cell, can be controlled at will. Fuel reforming capability allows fuel cost to be drastically reduced and refueling is eliminated; and the environmental impact of the electricity generation is reduced to zero, and the efficiency of the fuel cell is increased several folds.

In one aspect of the disclosure described herein, the fuel cell system, method, and apparatus begins with an anode reaction. In conventional hydrogen fuel cells, hydrogen is used as fuel, whereas in the present disclosure described herein hydrogen is used as an energy carrier. This means, in the prior art the fuel is consumed, while in the present disclosure described herein it is not. Secondly, this disclosure described herein allows control of the rate of electricity generation at the anode by manipulating the speed of travel of the proton carrying fluid, and eliminates several hardware used in conventional fuel cells.

Here, the fuel cell method, system, and apparatus of the present disclosure described herein provides the following advantages: (1) It eliminates the formation of exhaust matter, which leads to important improvements over the conventional art; (2) eliminates the need for refueling; eliminating the need for a network of refueling stations, which is important for mobile applications; (3) eliminates the need for the use of oxygen at the cathode, as well as the oxygen delivery system, and hardware used to deliver fuel and oxygen to the cell reaction sites; (4) reduces the emission of greenhouse gases to nearly zero, which occurs during the initial hydrogen extraction from carbohydrates, not in the process of creating electricity; (5) allows mechanical, physical and chemical acceleration of carrier fluid containing protons towards the cathode, not just by the slow diffusion of protons in carrier fluid, as is the case for conventional fuel cells; thus, electricity forming reactions at the anode can be made to speed up, allowing control of the rate of electricity formation at the anode. Hence, one aspect of the disclosure described herein is to provide cheap and pollution free energy by providing a sealed chamber filled with flowable ionizable matter as energy carrier and containing at least one anode and one cathode. In addition, the system and method does not require oxygen, has a sealed reaction chamber that preserves hydrogen, hydrogen is regenerated at the cathode and used repeatedly, and proton transfer is fast and controllable wherein proton loaded carrier fluid (e.g., water) is accelerated by an applied force, thereby producing high current, voltage, and power.

The following is one non-limiting exemplary embodiment of a method of operation of the energy production system, process, and apparatus of the disclosure described herein:

(1) At the anode, flowable ionizable matter such as hydrogen present in the chamber atmosphere and carrier fluid is ionized thereby releasing electrons and positively charged ions. Ionization is aided by a catalyst, and by the availability of a carrier fluid to attract freed protons. Thus, begin two circuits, one carrying electrons, and the other positively charged ions (protons), managing of which is the basis of this disclosure described herein.

(2) Next, the first circuit named the load circuit, consisting of the freed electrons traveling along a conductor to a load, such as a light bulb, or a heater element, or some other device perform work. Electrons then return from the load to the cathode.

(3) Next, the second circuit, named the proton circuit, carries the freed protons to cathode, utilizing a carrier fluid as an intermediary vehicle to carry the protons to cathode. The speed of travel of the carrier fluid, therefore the efficiency of electricity generation can be controlled by applying a force means to the proton carrying carrier fluid. Said force means may be physical, chemical, or mechanical in nature.

(4) Next, at the cathode, electrons returning from the load circuit combine with the protons arriving from the anode and form electronically neutral flowable ionizable matter. The said neutral flowable ionizable matter is then released to said chamber atmosphere, while some may remain in said fluid carrier, and both become available for ionization once again at the anode.

(5) Then, said fluid carrier means continue to said anode completing the said two circuits. The neutralized flowable ionizable matter, continuously ionized at said anode, and continuously reformed at said cathode, lead to continuous creation of electricity at said anode.

Here, fuel cell apparatus, system, and method of energy production of disclosure described herein provides flowable ionizable matter, such as hydrogen, to be used as an energy carrier rather than fuel. This allows said hydrogen to reform at said cathode, back to its original neutral form, instead of forming a waste product. Further, the apparatus, system, and method of energy production of disclosure described herein increases the rate of electricity generation by use of said force means to increase, or otherwise to control the rate of proton movement on the proton circuit, in addition to proton diffusion within the carrier fluid. In another aspect of the disclosure described herein, the apparatus, system, and method of energy production of disclosure described herein provides a control over the rate of anode reactions to control the rate of electricity generation, by utilizing said force means to control said speed of proton movement along said proton circuit.

The apparatus, system, and method of energy production disclosure described herein also provides an electricity generating process that is scalable, thereby allowing large electricity generating fuel cell reactors to be built. In addition, it provides mobile energy producing devices that do not require refueling, nor a series of refilling stations along highways. In addition, disclosure described herein further eliminates the use of oxygen in fuel cells, so that no exhaust forming reaction occurs within or outside of said fuel cell chamber. Further, disclosure described herein operates the fuel cell within a sealed chamber to preserve said ionizable flowable matter and without fear of poisoning by carbon monoxide and other impurities originating from the use of air (oxygen) supplied to the cathode. In addition, the disclosure described herein also produce electricity with zero emission of greenhouse gasses. The apparatus of the disclosure described herein can also be produced as a stack and may be connected in series or parallel to meet the output voltage and current requirements. Further, disclosure described herein uses very small amounts of hydrogen, but cycles it in order to use it repeatedly. Further, since there will be no need to store large amounts of hydrogen in cars, the assumed dangers will thus disappear proportionately. This too is a feature of the present disclosure described herein. The apparatus, system, and method of energy production disclosure described herein further reduces the cost of producing electricity so that even the poorest or the remotest areas of the world can have clean energy, for example, to pump water from the ground, or obtaining cheap energy for lighting, refrigeration, air conditioning, and operation of other such electrical devices.

In one aspect of the disclosure described herein, a fuel cell system for producing electricity, the fuel cell system including a sealed chamber having a first and second electrode separated from each other, wherein the first electrode has an anode and the second electrode has a cathode; a load circuit disposed outside of the chamber and in electrical communication with the anode; flowable ionizable matter disposed within the chamber, wherein the anode causes the flowable ionizable matter to ionize and produce electrons to move to the load circuit and return to the cathode; a second proton circuit, wherein the ionization at the anode also produces positively charged ions moving to the cathode from the second proton circuit; a carrier fluid for carrying the positively charged ions traveling therein; and wherein the returning electrons from the load circuit and positively charged ions from the second proton circuit combine at the cathode, thereby reforming the flowable ionizable matter, and further wherein the reformed flowable ionizable matter is at least partially released within the chamber thereby continuing the ionization reaction at the anode.

In addition, the system includes wherein the first or second electrode comprises a catalyst for facilitating the ionization and the reformation of the flowable ionizable matter. Further, the carrier fluid can include water, wherein the carrier fluid travels within the chamber while in a liquid stream, a solid particle stream, or in the form of droplets. In addition, the system can further include a force component for moving the carrier fluid from the anode to the cathode, and back to the anode. Here, the force component can be at least one of: one or more water pumps, a centrifugal force, magnetic force, gravity, surface energy, capillary action, and a hydraulic force. In addition, the carrier fluid does not return to the anode and is released to the outside environment. Further, the fuel cell produces electricity, and wherein the production of electricity is controlled by controlling the energized traveling speed of the carrier fluid from the anode to the cathode and back to the anode.

In another aspect of the disclosure described herein, a fuel cell system for producing electricity is disclosed including a sealed chamber having a first and second electrode separated from each other, wherein the first electrode is comprised of an anode and the second electrode is comprised of a cathode; a porous material disposed between the anode and cathode within the chamber, wherein the membrane is permeable to a carrier fluid but not permeable to electrons; a load circuit disposed outside of the chamber and in electrical communication with the anode; flowable ionizable matter filled within the chamber, wherein the anode causes the flowable ionizable matter to ionize and produce electrons to move to the load circuit and return to the cathode; a second proton circuit, wherein the ionization at the anode also produces positively charged ions moving to the cathode from the second proton circuit via the carrier fluid; and wherein the returning electrons from the load circuit and positively charged ions from the second proton circuit combine at the cathode, thereby reforming the flowable ionizable matter, and further wherein the reformed flowable ionizable matter is at least partially released within the chamber thereby continuing the ionization reaction at the anode.

In addition, the system includes wherein the carrier fluid travels within an interior region of the chamber. Further, the reformed flowable ionizable matter travels within the carrier fluid from the cathode to anode outside of the chamber. In addition, the carrier fluid is in at least one of: a gaseous state, liquid state, liquid droplets, liquid mist, and any other flowable physical state. Further, the system includes wherein a portion of the reformed flowable ionizable matter is carried from the cathode to the anode within the carrier fluid and participates in the ionization process at the anode. Further, the ionizable flowable matter is selected from at least one of: ionizable gasses in atomic or molecular form, solid flowable ionizable particles of elements or compounds, and ionizable elements or compounds comprised of hydrogen, chlorine, cesium, potassium, or sodium. In addition, the carrier fluid does not return to the anode and is released outside environment. Here, the fuel cell produces electricity, and wherein the production of electricity is controlled by controlling the energized traveling speed of the carrier fluid from the anode to the cathode and back to the anode. In addition, the system includes a force component, wherein the force component controls the travelling speed of the carrier fluid, and wherein the force component is comprised of one or more of physical, chemical, mechanical, and centrifugal forces. Here, the force component can include at least one of: water pumps, centrifugal force, magnetic force, gravity, surface energy, capillary action, and hydraulic force. Here, the chamber further includes one or more resealable ports for instrumentation configured to monitor, control, or maintain production of electricity at desired levels, and one or more ports for resupplying electrons and ionizable flowable matter lost to the environment.

In another aspect of the disclosure described herein, a method of producing electricity via a fuel cell, the method including flowing ionizable matter within a chamber, wherein the chamber comprises a first and second electrode separated from each other, wherein the first electrode is comprised of an anode and the second electrode is comprised of a cathode; ionizing the ionizable matter via the anode to produce electrons and positively charged ions, wherein the electrons move to a load circuit and return to the cathode, and wherein the positively charged ions move via a carrier fluid to the cathode via a proton circuit; and combining the returning electrons from the load circuit and positively charged ions from the second proton circuit combine at the cathode, thereby reforming the flowable ionizable matter, wherein the reformed flowable ionizable matter is at least partially released within the chamber, thereby continuing the ionization reaction at the anode.

The above summary is not intended to describe each and every disclosed embodiment or every implementation of the disclosure. The Description that follows more particularly exemplifies the various illustrative embodiments.

### BRIEF DESCRIPTION OF THE DRAWINGS

The following description should be read with reference to the drawings, in which like elements in different drawings are numbered in like fashion. The drawings, which are not necessarily to scale, depict selected embodiments and are not intended to limit the scope of the disclosure. The disclosure may be more completely understood in consideration of the following detailed description of various embodiments in connection with the accompanying drawings, in which:

FIG. 1 illustrates a schematic drawing showing a direction of electrons and positively charged ions (protons) within one non-limiting exemplary embodiment of a sealed fuel-cell reaction chamber of the disclosure described herein. Small arrows shown outside the chamber, show electron movement direction as part of the “load circuit,” and the large arrows show the direction of positively charged ion (proton) traveling within a carrier fluid on the “proton circuit.”

FIG. 2 illustrates a simplified cross-sectional view for one non-limiting exemplary embodiment an energy apparatus design utilizing the process described in FIG. 1. In the embodiment of FIG. 2, the apparatus utilizes only a pair of an anode and a cathode, and gravity as a “physical” force moves (large arrows) carrier water carrying positively charged ions (protons), and a mechanical pump providing force to return the carrier water back to top reservoir.

FIG. 3 illustrates a simplified cross-sectional view for another non-limiting exemplary embodiment of an energy apparatus utilizing the process described for this disclosure described herein in FIGS. 1 & 2, but shown with multiple anodes and cathodes.

FIG. 4 illustrates a simplified cross-sectional view for another non-limiting exemplary embodiment an energy apparatus designed to utilize the process of FIG. 1, wherein the carrier water is moved between electrodes by centrifugal force created by the rotation of the two electrodes (anode and cathode). And a pump placed outside the chamber providing force to return the carrier water collected at the bottom of the chamber to a central reservoir.

FIG. 5 is a perspective view of the energy apparatus of FIG. 4, illustrating a water pump at one end, and a motor utilized to rotate the electrodes at the other end.

### DETAILED DESCRIPTION

In the Brief Summary of the present disclosure above and in the Detailed Description of the disclosure described herein, and the claims below, and in the accompanying drawings, reference is made to particular features (including method steps) of the disclosure described herein. It is to be understood that the disclosure of the disclosure described herein in this specification includes all possible combinations of such particular features. For example, where a particular feature is disclosed in the context of a particular aspect or embodiment of the disclosure described herein, or a particular claim, that feature can also be used, to the extent possible, in combination with and/or in the context of other particular aspects and embodiments of the disclosure described herein, and in the disclosure described herein generally.

The embodiments set forth below represent the necessary information to enable those skilled in the art to practice the disclosure described herein and illustrate the best mode of practicing the disclosure described herein. In addition, the disclosure described herein does not require that all the advantageous features and all the advantages need to be incorporated into every embodiment of the disclosure described herein.

The process, system, and apparatus of the disclosure described herein mainly relies on two charged particle circuits, one for electrons, the other for protons. Here, both circuits start at the anode by ionization of a flowable ionizable matter like hydrogen & end again at the anode. Further, both circuits cross the electrodes that are placed inside an enclosed fuel-cell chamber. The two circuits create electricity at the anode, and reform the energy carrier at the cathode. The disclosure described herein describes said two circuits and the various ways the two circuits maybe made more efficient in creating electricity. Said anode and said cathode being inside a gas tight sealed chamber filled with flowable ionizable matter.

For simplicity of explaining the disclosure described herein, as used herein “flowable ionizable matter” can be hydrogen, “positively charged ions” can be referred to as protons, and proton carrying “carrier fluid” can be water. The electron circuit can be referred to as the “load circuit,” and the positively charged ion circuit can be referred to as the “proton circuit.”

What differentiates the system, process, and apparatus of the energy production disclosure described herein from the conventional fuel cells include:

(1) Cathode reactions do not involve oxygen, and thus, no waste products are formed. Instead, electrons returning from the load circuit combine with protons to reform the hydrogen.

(2) In conventional fuel cells, protons generated at the anode travel only by diffusion across a non-electron conducting ionic conductor, i.e., electrolyte membrane. However, in this disclosure described herein, proton travel to the cathode occurs while in a proton carrier liquid as protons and water molecules couple as hydronium ions. Proton carrying liquid carrier may be accelerated, independent of any diffusion of protons within said liquid. This can occur under a force means across an empty space between anode and cathode, rather than across an electrolyte membrane as is the case in conventional fuel cells. Said empty space preventing electron travel to anode from the cathode. Thus, giving this disclosure described herein a capability not available in conventional fuel cells: increasing the speed of travel of the protons to the cathode or increasing the rate of electricity generation per unit time at the anode.

(3) Proton travel from the anode to the cathode, being the reaction rate controlling step, in this disclosure described herein thus can be controlled by controlling the speed of travel of proton carrying fluid by a force means that may be physical, chemical, or mechanical in nature, rather than just diffusion energized by a proton concentration gradient.

(4) The system, process, and apparatus of the energy production of the present disclosure described herein when compared to the conventional polymer electrolyte membrane fuel cells (PEMFC) provides much simpler construction. Whereas hardware like electrodes are kept, membrane electrode assembly (MEA), the heart of the PEMFC is eliminated along with the required gaskets. Gas diffusion layers (GDL), bipolar plates, oxygen delivery hardware are also eliminated, since there is no need for oxygen. However, a small hydrogen tank nearby can supply more hydrogen into the chamber to replace any hydrogen lost to environment, as may be necessary. Otherwise, if there was no loss of hydrogen to the environment the hydrogen originally loaded into the chamber is reformed and used repeatedly.

Further, electrodes are anode and cathode and are made of porous and preferably water permeable conductors. Anode surface may have catalysts, such as platinum particles embedded and exposed, or a coating of platinum on the conductor surface. A catalyst may also be used on the cathode as well if necessary. The process of this disclosure described herein involves the generation of electricity at the anode placed inside a sealed chamber containing hydrogen gas (flowable ionizable matter) as energy carrier. Said chamber containing at least one anode and one cathode. Where, at the anode hydrogen is ionized releasing electrons and positively charged ions (protons). The latter form temporary bonds with water (proton carrying liquid); thus, forming hydronium ions (H3O+) that electronically behave like positively charged water molecules, or simply like protons, which are quickly removed from the ionization site in said liquid carrier. Hydronium ions make the water highly conductive, thereby making the spontaneous hydrogen reforming reaction at the cathode possible. Further, the sealed chamber allows preservation of carrier liquid and the fuel (hydrogen). This is not possible in conventional fuel cells due to the potential reaction between hydrogen and oxygen.

The two circuits, one carrying electrons, and the other protons, which are the basis of this disclosure described herein will be further discussed. Here, the first circuit, named the load circuit, can include the freed electrons traveling along a conductor to a load, such as a light bulb, or a heater element, or some other device to perform work. Further, electrons return from the load to the cathode. The second circuit, named the proton circuit, carries the freed protons to cathode, utilizing water as an intermediary vehicle to carry the protons to cathode. At the cathode, electrons returning from the load circuit spontaneously combine with the protons, reforming electronically neutral hydrogen.

Said reformed hydrogen atoms or molecules are either released to the chamber atmosphere or sent to the anode while still in solution in water, or both. At the anode this whole process is repeated once again. Variations of the apparatus based on this disclosure described herein may utilize the following:

(1) Various sizes and shapes of said sealed chamber;

(2) said sealed chamber may be made of various engineering materials, such as metals, ceramics, plastics, specifically selected to be durable while exposed to hydrogen or any other ionizable matter it is filled with. It may have sealable or resealable holes for maintenance, which may be used for draining or resupplying of hydrogen, water, and electrons; or, for cleaning; or repairing said chamber, and/or its contents;

(3) said sealed chamber, in some variations of the basic design of the apparatus of this disclosure described herein, may also be designed to accommodate a supply of carrier fluid that enters the chamber and leaves the chamber after carrying protons to cathode, and reforming said hydrogen. And that supply of fluid carrier may be water or some other fluid;

(4) said ionizable flowable matter can be gaseous matter such as hydrogen, in the form of atoms and or molecules, or chemical compounds, they may be in solution in a carrier fluid, wherein they maybe powdered materials such as nanometer or micrometer sized solid particles with surface electronic properties suitable for easy ionization;

(5) depending on the type of ionizable material, said positively charged ions may travel from said anode to said cathode by attaching themselves to a carrier, which may be gaseous, liquid, or solid, molecules, droplets, mist or small solid particles. Said positively charged ion and carrier combinations traveling to said cathode;

(6) anodes and cathodes with different materials, catalysts, sizes, shapes, and structures having different permeability for carrier fluid used; and, have different reaction surface area to volume ratios;

(7) the route taken for the said two circuits may be all inside said sealed chamber, or partially outside of said chamber;

(8) movement of said protons from the anode to the cathode may be energized by chemical concentration gradient within said carrier water, and/or by a physical, chemical, and mechanical means of moving said water, including, but not limited to, gravity, explosives, impact, capillary action (surface energy), centrifugal force, magnetic force, and vibrations, or by any combination of these energizing effects;

(9) movement of said water from cathode to anode may take place via a piping means placed inside, or outside of said sealed chamber. Such movement may be energized by a water pump, gravity, capillary (surface energy) action, movement of the whole chamber assembly, or by any other physical/mechanical force, or any combination of these, or it never takes place and said water is continuously supplied to the chamber and leaves continuously in the same electronical state it entered the chamber;

(10) there may be instrumentation attached to said chamber, inside or outside of it, measuring internal pressure of said hydrogen (ionizable matter), and, any excess or short coming of electron content at the cathode, Ph of the carrier fluid, and periodically and automatically compensating for both. Similarly, there may be instrumentation monitoring and controlling level of electricity generation, and any other functionally important information gathering instrument; and

(11) after said ionization at the anode, two electronic circuits are formed; one for the electrons, the other for the protons. The rate of electron and proton generation at the anode is the same at first instance. However, electrons are available at the cathode much faster than the protons in their perspective circuits. Therefore, the rate of electricity generation, given every other factor being equal, depends on how fast the protons travel on the proton circuit. With this background, it makes sense to accelerate the movement of protons on proton circuit. In the present disclosure described herein, unlike conventional fuel cells which rely on diffusion only, protons are attached to a carrier fluid, and the carrier fluid itself may be accelerated towards the cathode, then back to anode by mechanical, physical, or chemical means, such as centrifugal force, gravity, magnetic force, capillary action or any other surface energy action.

Here, the load circuit (or circuits) extends outside the chamber traversing one or more loads that may be any device that requires electricity to operate. In the load circuit, an electron conducting material such as a metal wire is needed to conduct the electrons. For a longer autonomous operation of the energy generating apparatus according to this disclosure described herein, certain necessary precautions, known to those familiar with such engineering disciplines, need to be taken to prevent any loss of electrons, hydrogen, or protons to the environment. In the proton circuit, the protons forming at the anode may be moved along the proton circuit by chemical diffusion within the carrier fluid, and/or by movement of said carrier fluid using a physical-mechanical-chemical means.

Diffusion of protons occurs from a higher concentration of protons to lower concentration in water. Diffusion typically starts at the instance of ionization, and involves protons moving from one water molecule to the next 4. When a proton is attracted to a water molecule, the temporary combination is called a hydronium ion (H₃O⁺) with a positive charge, wherein it may also be simply called a “proton.” Hydronium ion formation is a natural and spontaneous occurrence due to the ‘V’ shape of the water molecule, and the extended force field of the Oxygen atom so that no external energy is needed to accomplish it.

In the absence of any additional physical or mechanical or chemical means of said moving of protons, diffusion of said protons alone is slower, and yet can be enough to move the protons to said cathode in a carrier fluid like water. Further, physical, mechanical, or chemical force means of moving the protons along the proton circuit can take place by physically moving said proton loaded water. Said moving can be energized by gravity, or by centrifugal force, or by hydraulic force, capillary action of surfaces, magnetic force, or by any combination of these or by any other physical/mechanical/chemical means. The speed of said process of moving may be controlled to increase or decrease the rate of electron and proton creation at the anode, thus, also the amplitude of the current generated there.

The system, process, and apparatus of the energy production of the disclosure described herein will include at least one pair of electrodes, one anode and one cathode, within the fuel cell chamber; however, multiples of electrodes can be used to increase the current or the voltage or both, depending on how they are connected to each other. Anodes and cathodes maybe separated by free space, or by a felt like material that is permeable to water, or by an electrolyte membrane the allows proton diffusion, while blocking electron conduction.

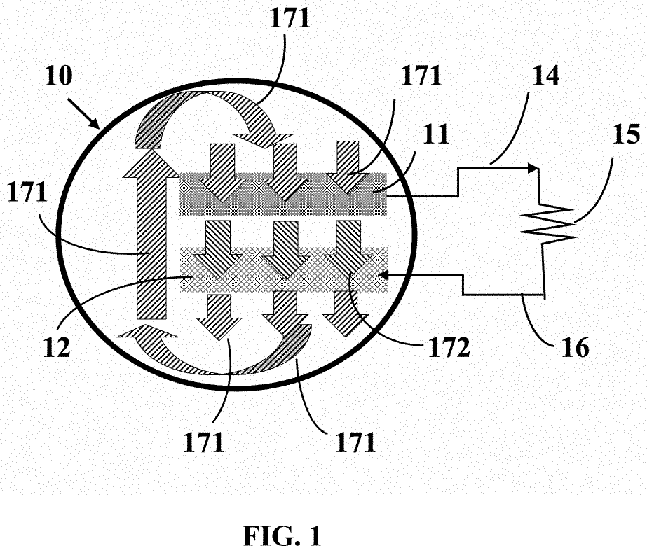

FIG. 1 illustrates a schematic representation showing directions of electrons and positively charged ions within a sealed reaction fuel-cell chamber 10 as offered by this disclosure described herein. Said chamber 10 is filled with the ionizable flowable matter, such as ionizable atoms or molecules of hydrogen, or some other suitable gas, or nano-particles with excess surface electrons that could easily be removed. Chamber 10 may be constructed of any of the common engineering materials, such as plastics, metals, and ceramics. If hydrogen is used as an energy carrier, it is preferred that the material of construction be a material having resistance to the detrimental effects of hydrogen, such as certain plastics, ceramics, or metals like copper. Chamber 10 can be initially filled with the flowable ionizable matter atoms such as hydrogen. Chamber atmosphere may have pressures higher than the sea level pressure of air. Higher pressures would be expected to increase the ionization rate per unit time, thus the electricity production at the anode.

Still referring to FIG. 1, chamber 10 may have valves that maybe opened for replenishing the chamber hydrogen and/or electrons that may have been lost to the environment (leaks, combining with materials, etc.). It may also have an access door large enough to repair or replace portions of the cell worn down, or chemically affected someway to hinder its functionality. The electrical energy forming process starts at anode 11, by ionization of hydrogen, which may be in the form of atoms or molecules. At anode 11, hydrogen atoms are ionized to give up their electrons to the electrode conductor, creating a concentration gradient of electrons in the conductor of the load circuit thereby causing electrons flowing 14 to load 15, and from there flowing 16 to cathode 12, under the gradient of potential energy of electrons created between anode 11 and cathode 12. Electron flow direction is indicated via arrows 14 and 16, as shown in FIG. 1. Load 15 may be a light bulb, or a heating element, or any electronic device such as a radio, a computer, telephone, or an electric motor, etc.

Similarly, at anode 11, protons created are ready to be attracted by water molecules of the carrier water, and form hydronium ions and move in the direction of cathode 12 through the proton circuit. Both electrons and protons, move under the influence of a concentration gradients; electrons inside the conducting wire, protons inside the carrier water. Both are headed towards the cathode, but, in two separate circuits. Proton movement can be accelerated by physical/mechanical/chemical force means, such as gravity, centrifugal force, magnetic pull, or by surface energy effects of surfaces and molecules, or by their combinations. Further, protons (H⁺) diffuse by temporarily attaching themselves to water molecules (H₂O) due to the shape of the water molecule, and the extended charge field of the Oxygen atoms, and hopping from one water molecule to the next under the push of the concentration gradient. Thus, temporarily forming positively charged hydronium ions (H₃O⁺) along the way. Hydronium ions may be considered as protons, since protons are just weakly attached to the water molecules. And can react with electrons forming neutral hydrogen atoms. Protons move towards cathode 12 with the effect of the concentration difference, and additionally by said physical/mechanical/chemical force means.

Still referring to FIG. 1, the concentration gradient occurs because the protons created at anode 11 start with a higher concentration there, and end with a lower, near zero concentration at cathode 12, where they combine with electrons returning from said load circuit. This reaction creates neutral hydrogen atoms, or even molecules at the cathode, which are released to the chamber atmosphere, while some may remain in said fluid carrier and be carried to anode for ionization. In addition, continuously supplied (carrier) water 171, which may be in the form of droplets, or stream, or even mist, moving under the pull of the gravity downward increases the electron potential energy gradient in the load circuit; and, increases the rate of proton movement from anode 11 to cathode 12. This, rate increase being in addition to the diffusion of protons in water, increases the rate of ionization at the anode. Thus, more electrical energy is produced as opposed to just relying on the naturally occurring ionic diffusion in the carrier fluid.

Still referring to FIG. 1, assuming anode 11 and cathode 12 are separated by an empty space, water droplets move down 171 entering anode 11, and continue moving down towards cathode 12, traversing 172 the empty space between anode 11 and cathode 12, while being loaded with protons and protons (as hydronium ions) moving down 172 with the gravity. As faster the protons are removed from anode 11 where they are created, then the more ionization of hydrogen at anode 11. Here, this is where physical/mechanical/chemical removal of the protons by such forces as gravity and centrifugal force, or capillary action can be used. The proton concentration gradient within the carrier water, acting together with the physical/mechanical/chemical removal of proton containing water increase the rate of ionic movement, as well as the current output at anode 11.

Still referring to FIG. 1, at cathode 12, hydronium ions combine with electrons returning 16 from performing work at load 15, and the two spontaneously react to form water and hydrogen:

2H₃O++2e⁻→2H₂O+H₂

This, in fact is a reforming process as it spontaneously reforms the initial neutral hydrogen atom. Most hydrogen atoms thus formed may combine with other hydrogen atoms to form a hydrogen molecule. Hydrogen atoms and molecules thus formed at cathode 12 are either released to said chamber 10 atmosphere or remain in the carrier water. Either way, they would be available at the anode 11 once again for ionization into electrons and protons. The ionization reaction occurring at the anode, is the same reaction that occurs in conventional fuel cells at the triple points of anode catalyst/conductor+water carrier+hydrogen gas. In this disclosure described herein hydrogen may be in the chamber atmosphere or in solution in carrier water. Increasing hydrogen pressure in chamber 10 should increase current generated. Chamber temperature will influence the activation energy needed for ionization at the anode; reducing it at higher temperatures. A part of the current generated may then be used to increase the anode temperature if so desired. If so, after heating anode 11, the used electrons should also be directed to cathode 12.

Still referring to FIG. 1, electrons moving 14 on load 15 circuit (via arrows 14 and 16) towards cathode 12, while the protons moving towards cathode 12 via the proton circuit represented by arrows 171 and 172. It is preferred that, after passing through cathode 12, there remains no free electrons in the carrier water so that proton-electron reaction at anode 11 is avoided. Here, this may reduce efficiency of production of the current at anode 11. To increase reaction rate, both electrodes anode 11 and cathode 12 may be constructed as having porous structure, which are designed to be permeable to water, as well as providing large reaction surface area. It is preferred that both electrodes not impede water droplet flow due to pore size and/or surface tensional effects, which may be controlled by special coatings to allow easy water flow through anode 11 and cathode 12.

Still referring to FIG. 1, the anode 11 electrode typically will have a catalyst to aid ionization reaction there. The catalyst, such as platinum, may be present on the electrode either as embedded particles or as a coating. The fuel cell process of this disclosure described herein for the case of hydrogen being used as the energy carrier, can be represented by the following chemical reactions:

At the anode: H₂→2H⁺+2e⁻ (electrons are directed to the load circuit, and then to the cathode)

H⁺+2H₂O→2H₃O⁺ (hydronium ions are directed towards the cathode as part of the proton circuit)

At the cathode: 2H₃O⁺+2e⁻→2H₂O+H₂

Overall reaction: H₂→H₂

Here, the anode ionization reaction is endothermic, so it requires some energy, which in this disclosure described herein is provided by some of the electricity generated by the fuel cell of the disclosure described herein itself. The use of a catalyst on the conductor of the anode reduces the energy required. The reaction to produce hydronium ions, and the reaction at the cathode are spontaneous slightly exothermic reactions that produce some heat. In the present disclosure described herein hydrogen is used as the energy carrier, ionized at the anode, and reformed in the cathode instead of forming waste products. This way, the problems associated with the conventional hydrogen fuel cells are eliminated, such as fuel cost, costs associated with handling air and hydrogen supply, and refueling stations. Further, environmental damage and greenhouse gas released at the hydrogen gas forming plants are also largely eliminated.

Here, eliminating the use of oxygen (or air) to remove (hydrogen) protons from the system further eliminates exhaust waste products and associated exhaust hardware. Additionally, the elimination of the use of air or oxygen gas eliminates poisoning of the anode due to impurities present in air, such as carbon monoxide. Fuel and oxygen supply hardware, in the conventional fuel cells, are precise, delicate, and require assembly are eliminated in the present disclosure described herein. Further, the use of hydrogen as a carrier of energy rather than fuel that is consumed, greatly reduces the cost of hydrogen needed. This also largely eliminates the need for refueling stations for mobile fuel cell systems, such as those used in vehicles, laptops, cell-phones, and similar devices. In addition, depending on the materials of construction of the fuel cell system, from time-to-time there may be a need for replenishing the hydrogen lost to surroundings or by leakage. Hydrogen atom being very small, can attach itself to anything, and can leak though the tiniest of cracks.

Similarly, from time to time, compensation for the electron loss in and out of the chamber, or in the load circuit, maybe necessary. An automatic sensing of the need for electron compensation, and automatic electron infusion into the cathode maybe useful. Here, if instead of hydrogen, another ionizable flowable matter is used as an energy carrier, the ionizable matter would behave like the hydrogen atoms in giving up one or more of their outer electrons at the anode, and the remaining positively charged ions, carried to the cathode in a carrier fluid would combine with the returning electrons at the cathode, thereby reforming the original ionizable matter. Accordingly, it is contemplated within the scope of the present disclosure described herein that other types of ionizable flowable matter may be used in lieu of hydrogen or in combination thereof.

Further anodes and cathodes maybe separated by a non-conducting electrolyte as in conventional fuel cells, or, by free space to prevent electrons returning from the load circuit to cathode from traveling to the anode. A conductor in intimate contact with anode is provided for electrons to travel on the load circuit to said cathode, and a carrier fluid circuit (proton circuit) is provided for protons to travel from said anode to said cathode, and back to anode after receiving their electrons at the cathode.

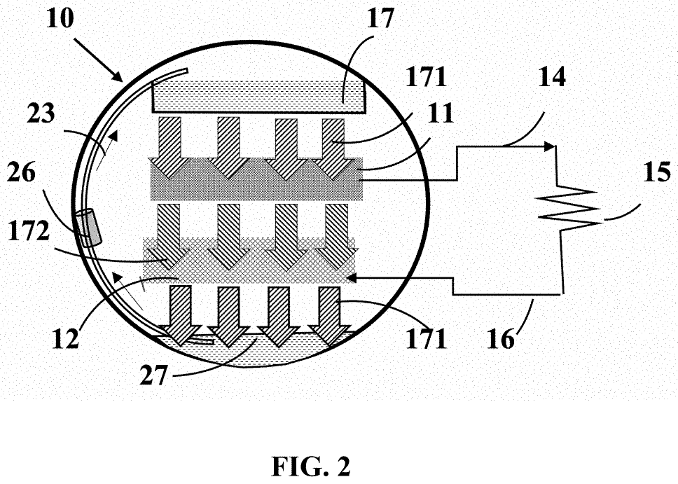

FIG. 2 illustrates another non-limiting exemplary embodiment of chamber 10 of the disclosure described herein involving anodes 11 and cathodes 12 being separated by free space to prevent electrons returning from the load circuit to the cathode from traveling to the anode. Only one pair of anodes and cathodes are shown in FIG. 2 to simplify description of the apparatus. Here, a conductor 14 in intimate contact with anode 11 is provided for the electrons to travel on load circuit 14, 15, and 16, to said cathode 12, and a (carrier) water circuit 17, 171, 172, 171, 27, and 26 is provided for protons, in the form of positively charged hydronium ions, to travel from said anode 11 to said cathode 12, and electronically neutral water from said cathode to the bottom water reservoir 27 to top water reservoir 17. Such movement of the water may be energized by several mechanical or chemical or physical means that may include a water pump 26, or capillary action, gravity, centrifugal force, magnetic force, or by other movement generating means.

Still referring to FIG. 2, gravity is shown to be the means to move the water containing positively charged hydronium ions from the anode to the cathode. However, this is not the only means to move hydronium ions towards said cathode. Within the water, hydronium ions diffuse to other parts of the droplets or stream, and lead to more hydronium ions being loaded with protons. At cathode 12, the positively charged hydronium ions spontaneously receive the electrons returning from the load circuit. Protons, combined with electrons reform hydrogen atoms, and/or molecules and are released into the chamber atmosphere. Some hydrogen may remain in the water; however, this does not affect the ionization process at the anode, rather it may speed the ionization process as the availability of hydrogen at the said triple points is increased. Further, proton free water collects in a reservoir 27 at the bottom of the chamber 10. And, from there it is pumped back to water reservoir 17 at the top of chamber 10. The proton circuit circulation of water before it reaches water reservoirs 17 and 27 should be mostly hydronium ion (proton) free water. This then describes how the proton circuit starts from the anode with hydronium ions, and ends again at the anode as neutral hydrogen, either in chamber 10 atmosphere, or within said water.

In another non-limiting exemplary embodiment, the water for reservoir 17 in FIG. 2 may also be supplied from the outside of chamber 10 and be released to outside from the bottom of chamber 10 continuously, after picking up protons from anode 11, and carrying to cathode 12 to combine with electrons there. This continuous supply of in-and-out water approach eliminates water pump 26, and the energy efficiency of the whole system would therefore be increased by the elimination of the energy used for pump 26. This approach may be preferable if enough, clean, and continuous water supply is available. Mainly, large stationary fuel cell systems may benefit from this approach, as described by this disclosure described herein. Noting that the water used for the fuel cell is not lost but could be used for other purposes.

In another non-limiting exemplary embodiment of the disclosure described herein involves an apparatus similar to the one shown in FIG. 2, wherein, instead of a free space between anode 11 and cathode 12, there is provided a felt-like material filling said space between the anode and the cathode at least partially and said felt-like material having a water permeable, and electrically non-conducting characteristics. This way if the fuel cell of this disclosure described herein is mounted on a mobile structure such as a car, water splashing due to vibrations can be prevented inside the chamber 10. Other means to prevent water splashing, such as eliminating spacing between the chamber wall and the sides of the anode and cathode, may also be useful. The foregoing alternative embodiments described herein with respect to the embodiment of FIG. 2, depend on two transport mechanisms for the protons: one being the diffusion of the protons in the carrier water, and the second mechanism involves the gravity, which may be in addition to diffusion transport of protons. Thus, provides a faster recirculation of the protons in the proton circuit as defined earlier, achieving an increased rate of current creation at anode 11.

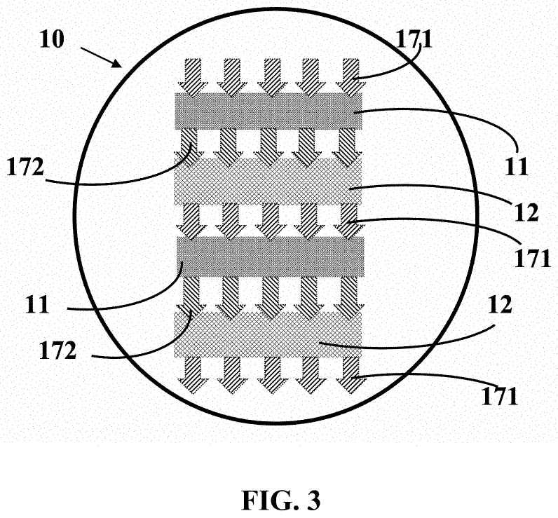

FIG. 3 depicts another non-limiting exemplary embodiment of a multi-anode and multi-cathode configuration of the apparatus in FIG. 2. As shown in FIG. 3, there is no upper limit to how many anode-cathode electrode couples may be placed in chamber 10. Further, the electron and the proton circuits function as described above with respect to FIGS. 1 and 2. Referring to FIG. 3, protons travel from anodes to cathodes where they combine with electrons and neutral hydrogen atoms are then released to chamber atmosphere at each cathode. Referring to FIG. 3, the water leaving the last cathode in the stack is returned to the anode using any of the physical, chemical, and/or mechanical means described before. Still referring to FIG. 3, the amount of current amplitude created, and the voltage of the apparatus depends on whether the anodes and cathodes are connected in series or parallel; and they also depend on anode and cathode surface area available for ionization and reforming reactions at both electrodes, as well as how fast the protons are circulated in the proton circuit.

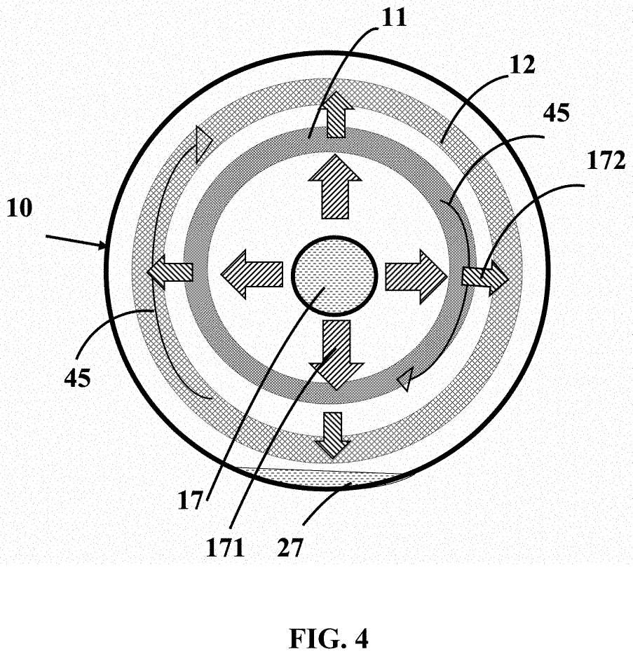

FIG. 4 illustrates another non-limiting exemplary embodiment of the disclosure described herein which involves further speeding of said protons on said proton circuit. One way of accomplishing this can be using centrifugal force. This requires the rotation 45 of the circularly placed anodes 11 and cathodes 12 inside chamber 10, as depicted in FIG. 4. Still referring to FIG. 4, the rotating anodes and cathodes propel neutral water 171, and proton carrying water 172 away from the centrally located water supply 17, in the direction of chamber 10 wall, using the same water to carry protons from successive anodes to cathodes, and after the reforming reaction at each cathode 11 passing neutral water on to the next cathode 12, and finally, allowing neutralized water to collect at reservoir 27.

Still referring to FIG. 4, water supply 17 which may be perforated to allow many water exit holes, which may also rotate or be fixed, depending on ease of construction and structural durability. Still referring to FIG. 4, the water is supplied though water piping 58 from reservoir 27, and its pressure is controlled by pump 56. As shown in FIG. 4, said water pressure at water supply 17 then partially controls the rate of proton circulation, thereby the rate of electricity generation at anodes 11 can be controlled as well.

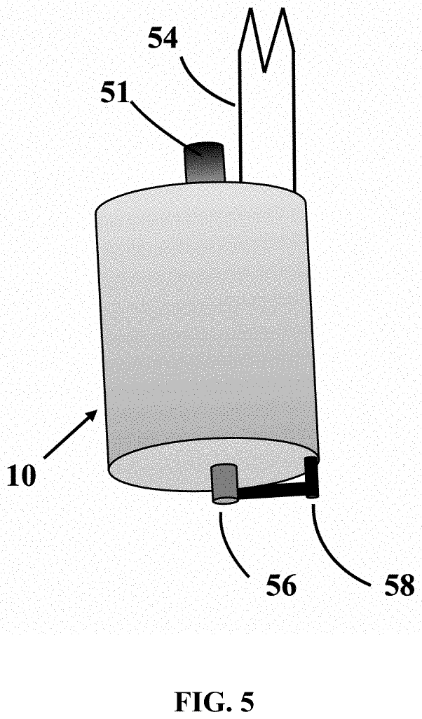

FIG. 5 illustrates an external perspective view of chamber 10 of a centrifugally powered water circuit design shown with respect to FIG. 4. As shown in FIG. 5, a motor 51, such as an electric motor, is provided or connected at one end of chamber 10 in order to rotate the internal anode-cathode assembly and the carrier water circulation from reservoir 27 to water supply 17 shown with respect to FIGS. 2 and 4. Referring to FIG. 5, the external portion of electron circuit 54 (which can have a load) is shown fixed on or connected to chamber 10, which requires that the electronic conduction go through a rotating brush or a conducting fluid intermediate connection, or similar other means to assure internal conduction continuity. Still referring to FIG. 5, pump 56 is also shown connected to another end of chamber 10 in communication with water piping 58. Further, the fluid circuit can be referred to a carrier fluid, such as water, that is allowed by gravitation (or by the wicking action of a wick, or centrifugal force, magnetic force, or by any other mechanical or electro-magnetic or chemical attraction means to physically travel to said cathode) carrying said positively charged ions, such as protons attached to water molecules called hydronium ions. Here, the protons and electrons returning from the two circuits meet at said cathode, and spontaneously react to reform said ionizable flowable matter, such as hydrogen atoms or molecules.

Within said chamber 10 of the disclosure described herein, assuming said fuel is hydrogen, the following three steps take place:

(1) Ionization of hydrogen at said anode; this means splitting hydrogen atoms into electrons and protons;

(2) freed electrons traveling in a circuit (load circuit) to perform work and returning to said cathode. This happens, because an electron concentration gradient occurs by extraction of new electrons from the fuel at the anode. The potential energy thus created, through a chemical reaction at said anode, energizes the electron movement across said load; and

(3) a similar concentration gradient occurs in the second circuit as well, this time involving protons created in step (1). Protons in contact with said carrier fluid (water) form temporary bonds with water molecules traveling to said cathode by hopping from one water molecule to the next, forming temporary hydronium ions on the way. At said cathode, they combine with returning electrons to reform said ionizable flowable matter (such as hydrogen atoms and molecules), which is released back to said chamber atmosphere. Some may remain in said carrier fluid, which is recirculated back to said anode for the process to repeat itself.

The following is one non-limiting example demonstrating a range for a vehicle using the fuel cell system and method of the disclosure described herein: Here, energy will come from the loss of hydrogen mass (E=MC²). Further, given the vehicle provides 100 kWh/Charge with a range of 400 miles, and assuming 0.01 g hydrogen mass converted to energy in the fuel cell system of the disclosure containing 10 g of hydrogen, and further given 1 kWh is 3,600,00 J, and 0.01 g of hydrogen energy is 0.09×1013 J=0.025×107 kWh, the range of the vehicle will be 0.025×107 kWh×(400 miles/100 kWh) thereby providing 1,000,000 miles of range.

From the foregoing it will be seen that the present disclosure described herein is one well adapted to attain all ends and objectives hereinabove set forth, together with the other advantages which are obvious, and which are inherent to the disclosure described herein.

Since many possible embodiments may be made of the disclosure described herein without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the disclosure described herein is not limited to the specific forms or arrangement of parts described herein, except insofar as such limitations are included in following claims. Further, it will be understood that certain features and sub-combinations are of utility and may be employed without reference to other features and sub-combinations. This is contemplated by and is within the scope of the claims

What is claimed is:

1. A fuel cell system for producing electricity, the fuel cell system comprising:
a sealed chamber comprised of a first and second electrode separated from each other, wherein the first electrode is comprised of an anode and the second electrode is comprised of a cathode;
a load circuit disposed outside of the chamber and in electrical communication with the anode;
flowable ionizable matter disposed within the chamber, wherein the anode causes the flowable ionizable matter to ionize and produce electrons to move to the load circuit and return to the cathode;
a second proton circuit, wherein the ionization at the anode also produces positively charged ions moving to the cathode from the second proton circuit;
a carrier fluid for carrying the positively charged ions traveling therein; and
wherein the returning electrons from the load circuit and positively charged ions from the second proton circuit combine at the cathode, thereby reforming the flowable ionizable matter, and further wherein the reformed flowable ionizable matter is at least partially released within the chamber thereby continuing the ionization reaction at the anode.

2. The system of claim 1, wherein the first or second electrode comprises a catalyst for facilitating the ionization and the reformation of the flowable ionizable matter.

3. The system of claim 1, wherein the carrier fluid is comprised of water.

4. The system of claim 1, wherein the carrier fluid travels within the chamber while in a liquid stream, a solid particle stream, or in the form of droplets.

5. The system of claim 1, further comprise a force component for moving the carrier fluid from the anode to the cathode, and back to the anode.

6. The system of claim 5, wherein the force component is comprised of at least one of: one or more water pumps, a centrifugal force, magnetic force, gravity, surface energy, capillary action, and a hydraulic force.

7. The system of claim 1, wherein the carrier fluid does not return to the anode and is released to the outside environment.

8. The system of claim 1, wherein the fuel cell produces electricity, and wherein the production of electricity is controlled by controlling the energized traveling speed of the carrier fluid from the anode to the cathode and back to the anode.

9. A fuel cell system for producing electricity, the system comprising:
a sealed chamber comprised a first and second electrode separated from each other, wherein the first electrode is comprised of an anode and the second electrode is comprised of a cathode;
a porous material disposed between the anode and cathode within the chamber, wherein the membrane is permeable to a carrier fluid but not permeable to electrons;
a load circuit disposed outside of the chamber and in electrical communication with the anode;
flowable ionizable matter filled within the chamber, wherein the anode causes the flowable ionizable matter to ionize and produce electrons to move to the load circuit and return to the cathode;
a second proton circuit, wherein the ionization at the anode also produces positively charged ions moving to the cathode from the second proton circuit via the carrier fluid; and
wherein the returning electrons from the load circuit and positively charged ions from the second proton circuit combine at the cathode, thereby reforming the flowable ionizable matter, and further wherein the reformed flowable ionizable matter is at least partially released within the chamber thereby continuing the ionization reaction at the anode.

10. The system of claim 9, wherein the carrier fluid travels within an interior region of the chamber.

11. The system of claim 9, wherein the reformed flowable ionizable matter travels within the carrier fluid from the cathode to anode outside of the chamber.

12. The system of claim 9, wherein said carrier fluid is in at least one of: a gaseous state, liquid state, liquid droplets, liquid mist, and any other flowable physical state.

13. The system of claim 9, wherein a portion of the reformed flowable ionizable matter is carried from the cathode to the anode within the carrier fluid and participates in the ionization process at the anode.

14. The system of claim 9, wherein the ionizable flowable matter is selected from at least one of: ionizable gasses in atomic or molecular form, solid flowable ionizable particles of elements or compounds, and ionizable elements or compounds comprised of hydrogen, chlorine, cesium, potassium, or sodium.

15. The system of claim 9, wherein the carrier fluid does not return to the anode and is released outside environment.

16. The system of claim 9, wherein the fuel cell produces electricity, and wherein the production of electricity is controlled by controlling the energized traveling speed of the carrier fluid from the anode to the cathode and back to the anode.

17. The system of claim 9, further comprising a force component, wherein the force component controls the travelling speed of the carrier fluid, and wherein the force component is comprised of one or more of physical, chemical, mechanical, and centrifugal forces.

18. The system of claim 9, wherein the force component is comprised of at least one of: water pumps, centrifugal force, magnetic force, gravity, surface energy, capillary action, and hydraulic force.

19. The system of claim 9, wherein the chamber further comprises one or more resealable ports for instrumentation configured to monitor, control, or maintain production of electricity at desired levels, and one or more ports for resupplying electrons and ionizable flowable matter lost to the environment.

20. A method of producing electricity via a fuel cell, the method comprising:
flowing ionizable matter within a chamber, wherein the chamber comprises a first and second electrode separated from each other, wherein the first electrode is comprised of an anode and the second electrode is comprised of a cathode;
ionizing the ionizable matter via the anode to produce electrons and positively charged ions, wherein the electrons move to a load circuit and return to the cathode, and wherein the positively charged ions move via a carrier fluid to the cathode via a proton circuit; and
combining the returning electrons from the load circuit and positively charged ions from the second proton circuit combine at the cathode, thereby reforming the flowable ionizable matter, wherein the reformed flowable ionizable matter is at least partially released within the chamber, thereby continuing the ionization reaction at the anode.
